(19) United States
(12) Patent Application Publication
(10) Pub. No.: US 2022/0274583 A1
(43) Pub. Date: Sep. 1, 2022

(54) POWERTRAIN UNIT HAVING ELECTRICAL MACHINE AND INTERNAL COMBUATION ENGINE; AND METHOD FOR OPERATING A POWERTRAIN UNIT

(71) Applicant: Schaeffler Technologies AG & Co. KG, Herzogenaurach (DE)

(72) Inventors: Markus BAEHR, Bühl (DE); Götz RATHKE, Hohberg (DE)

(73) Assignee: Schaeffler Technologies AG & Co. KG, Herzogenaurach (DE)

(21) Appl. No.: 17/637,850

(22) PCT Filed: Jul. 30, 2020
(86) PCT No.: PCT/DE2020/100680

§ 371 Date: Feb. 24, 2022

(30) Foreign Application Priority Data
Sep. 3, 2019 (DE) 10 2019 123 544.8

(51) Int. Cl. B60W 20/40; B60K 6/365; B60K 6/547; B60K 6/387; F16H 3/72

(52) U.S. Cl. CPC B60W 20/40; B60K 6/365; B60K 6/547; B60K 6/387; F16H 3/728; F16H 2200/2023; B60K 2006/4808

(57) ABSTRACT

A hybridised powertrain unit (1) for a motor vehicle is provided, with a first part-unit (3) having an electrical machine (2) and with a second part-unit (6) having an internal combustion engine (4) and a powershift transmission (5) connected downstream of the internal combustion engine (4), wherein the two part-units (3, 6) are coupled on the output side to an output drive (10) via a joint planetary gearbox (7), the ring gear (8) of which is connected to a transmission output (9) of the powershift transmission (5). A method for operating this powertrain unit (1) is also provided.

### CROSS-REFERENCE TO RELATED APPLICATIONS

This application is the U.S. National Phase of PCT Appin. No. PCT/DE2020/100680, filed Jul. 30, 2020, which claims priority from German Patent Application No. 10 2019 123 544.8, filed Sep. 3, 2019, the entire disclosures of which are incorporated by reference herein.

### TECHNICAL FIELD

The disclosure relates to a hybridized powertrain unit comprising an electrical machine (drive machine) and an internal combustion engine, wherein the powertrain unit is designed for use in a motor vehicle, such as a passenger car, truck, bus or other commercial vehicle. The disclosure also relates to a method for operating this powertrain unit.

### SUMMARY

It is the object of the disclosure to provide a powertrain unit that provides a drive with as little drag loss as possible in a purely electric drive mode and at the same time is as compact as possible, especially with a short axial design. At the same time, it should be possible to transmit a relatively high torque generated by the internal combustion engine to the output drive. Stationary charging should also be possible.

This is achieved according to the disclosure by the use of one or more of the features described herein. Accordingly, a hybridized powertrain unit for a motor vehicle, having a first part-unit having an electrical machine and a second part-unit having an internal combustion engine and a powershift transmission connected downstream of the internal combustion engine, wherein the two part-units are coupled on the output side to an output drive via a joint planetary gearbox the ring gear of which is connected to a transmission output of the powershift transmission.

On the one hand, this design enables the two part-units to be coupled as directly as possible to the output drive. On the other hand, the internal combustion engine can be switched off in a simple manner, namely by holding the ring gear of the powershift transmission, thus achieving that a purely electric drive can be selected as simply and directly as possible.

Further advantageous embodiments are explained in more detail below.

For an effective connection of the planetary gearbox to the electrical machine and the output drive, it is also useful if a rotor shaft of the electrical machine is connected in a non-rotatable manner (preferably permanently) to a sun gear of the planetary gearbox and/or a planet carrier of the planetary gearbox is connected to the output drive (preferably permanently).

If a (first) brake, preferably realized as a claw brake, acts on the ring gear of the planetary gearbox and holds the ring gear in its activated position relative to a transmission housing of the powershift transmission, a simply designed changeover device is provided for switching between a purely electric drive mode and a hybrid drive mode.

For the simplest possible setup, it is also beneficial if the powershift transmission has a Ravigneaux gear set or forms this Ravigneaux gear set directly.

Furthermore, it is advantageous if a ring gear of the powershift transmission is connected to the ring gear of the planetary gearbox. This results in a skillful direct coupling of the powershift transmission with the planetary gearbox.

It is also advantageous if an output shaft of the internal combustion engine can be connected to a first sun gear of the powershift transmission via a first clutch (preferably designed as a claw clutch), to a planet carrier of the powershift transmission via a second clutch (preferably designed as a friction clutch) and/or to a second sun gear of the powershift transmission via a third clutch (preferably also designed as a friction clutch).

Furthermore, it is advantageous if a (second) brake (preferably designed as a friction brake) is operatively connected to the first sun gear of the powershift transmission. This facilitates the controllability of the powershift transmission.

In this context, it is also expedient if a (third) brake (preferably designed as a friction brake) is operatively connected to the planet carrier of the powershift transmission. This makes it even easier to control the powershift transmission.

Furthermore, the disclosure relates to a method for operating a powertrain unit according to the disclosure according to at least one of the embodiments described above, wherein in a hybrid drive mode (preferably by opening/deactivating the first brake) the internal combustion engine drives the ring gear of the planetary gearbox via the powershift transmission, in addition to a drive power transmitted from the electrical machine to the planetary gearbox, and in a purely electrical drive mode (preferably by closing/activating the first brake) exclusively the electrical machine transmits drive power to the planetary gearbox, while the transmission output of the powershift transmission is supported/held fixed to the transmission housing.

In this context, it is also advantageous if, to change from the purely electric drive mode to the hybrid drive mode, the internal combustion engine uncoupled from the powershift transmission is first switched on, then a certain torque is built up in a claw brake holding the transmission output (preferably previously in an open position) by a targeted slipping operation of a friction clutch (preferably the second or third clutch of the Ravigneaux gear set) arranged between an output shaft of the internal combustion engine and a component of the powershift transmission, subsequently the claw brake is released/opened/deactivated, and again subsequently a speed adaptation between the output shaft of the internal combustion engine and the transmission output is performed, whereupon the friction clutch is completely closed.

If the speed adaptation between the output shaft of the internal combustion engine and the transmission output is performed by adapting the speed (of the rotor shaft) of the electrical machine (preferably by setting a negative speed/by generator operation), the switching operation is carried out with as few means as possible.

Furthermore, it is advantageous if, during a change from the hybrid drive mode to the purely electric drive mode, a friction clutch between the output shaft of the internal combustion engine and a component of the power shift transmission (preferably previously in a closed position) is brought into a targeted slipping operation and the speed of the transmission output is reduced, and subsequently, after the speed of the transmission output has reached or fallen below a lower speed limit value, a claw brake acting on the transmission input is closed/activated and the friction clutch is fully opened.

Furthermore, in a stationary charging mode, the output drive is preferably held fixed to the housing (e.g., by another brake), while the transmission output and the electrical machine are coupled to each other via the planetary gearbox.

For recuperation in hybrid drive mode, a drag torque of the internal combustion engine is preferably effectively increased by selective tensioning in the powershift transmission (operating a friction clutch in slipping operation as well as with the claw brake closed).

In other words, an e-powertrain having a speed-additive coupled range extender is realized according to the disclosure. A branch having an electrical machine (first part-unit) is coupled to an output drive via a planetary gearbox/planetary gear set. Preferably, the electrical machine is coupled to a sun gear and the output drive is coupled to a planet carrier of this planetary gear set. One branch of an internal combustion engine (second part-unit) also has a powershift transmission. An output (transmission output) of the powershift transmission is connected to a ring gear of the planetary gear set. In a purely electric drive mode, a claw brake is activated/engaged so that the ring gear is fixed relative to a transmission housing to hold the internal combustion engine in a stationary condition. In a hybrid drive mode, the claw brake is released/deactivated so that the internal combustion engine is operated in a rotating condition.

### BRIEF DESCRIPTION OF THE DRAWINGS

In the following, the disclosure is now explained in more detail with reference to figures.

In the figures:

FIG. 1 shows a schematic representation of a powertrain unit according to the disclosure, in which a coupling of two branches equipped with an electrical machine or an internal combustion engine and an output drive via a planetary gearbox is clearly visible, and

FIG. 2 shows a more detailed representation of the powertrain unit according to FIG. 1, wherein the internal structure of a powershift transmission connected downstream of the internal combustion engine can be seen.

### DETAILED DESCRIPTION

The figures are merely schematic in nature and are therefore intended solely for the purpose of understanding the disclosure. The same elements are provided with the same reference symbols.

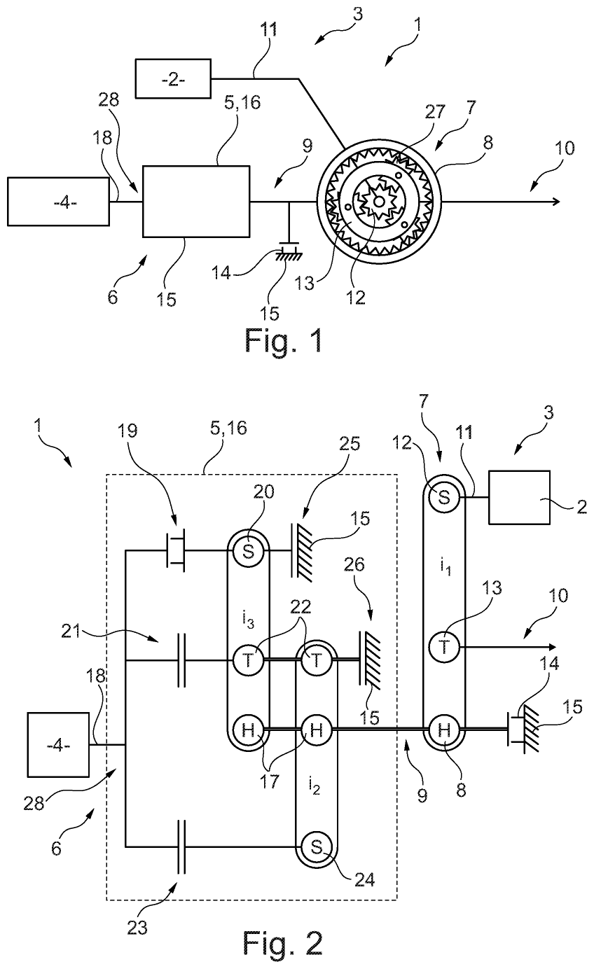

FIG. 1 shows the basic structure of a powertrain unit 1 implemented according to a preferred exemplary embodiment. In operation, the powertrain unit 1 is used to implement a purely electric drive mode in which only an electrical machine 2 outputs drive power to an output drive 10, and a hybrid drive mode in which an internal combustion engine 4 outputs drive power to the output drive 10 together with the electrical machine 2.

The powertrain unit 1 typically has two branches, hereinafter referred to as part-units 3, 6. A first part-unit 3 has the electrical machine 2. The electrical machine 2 is typically equipped with a stator fixed to the housing, which is not shown for the sake of clarity, and a rotor mounted so that it can rotate relative to the stator. A rotor shaft 11 emerging from the electrical machine 2 and forming the first part-unit 3 is connected in a non-rotatable manner to the rotor and is shown in simplified form in the figures. The rotor shaft 11 extends from the electrical machine 2 toward a planetary gearbox 7.

A second part-unit 6 of the powertrain unit 1 has an internal combustion engine 4 and a powershift transmission 5 connected downstream of the internal combustion engine 4. The internal combustion engine 4 is connected/couplable with its output shaft 18 to an input 28 of the powershift transmission 5. The powershift transmission 5 is connected downstream of the internal combustion engine 4 and extends with its transmission output 9 toward the planetary gearbox 7.

According to the disclosure, the two part-units 3, 6 are coupled to an output drive 10 via the joint planetary gearbox 7, here implemented as a single-stage planetary gearbox/a planetary gearbox having only one planetary gear set. The output drive 10 is implemented as a shaft, for example, and transitions into a differential gear.

It can also be seen in FIG. 1 that the first part-unit 3/the rotor shaft 11 is directly connected to the sun gear 12 of the planetary gearbox 7 in a non-rotatable manner. The powershift transmission 5 is connected with its transmission output 9 to a ring gear 8 of the planetary gearbox 7. A planet carrier 13 of the planetary gearbox 7 is directly connected to the output drive 10. In a typical manner, a plurality of circumferentially distributed planet gears 27 of the planetary gearbox 7 are rotatably mounted on the planet carrier 13 and are in meshing engagement with the ring gear 8 and the sun gear 12.

A first brake 14 is provided for switching the powertrain unit 1 between a purely electric drive mode, in which purely the electrical machine 2 drives the output drive 10, and a hybrid drive mode, in which both the electrical machine 2 and the internal combustion engine 4 drive the output drive 10. This first brake 14 is implemented as a claw brake. The first brake 14 interacts with the transmission output 9/the ring gear 8 of the planetary gearbox 7. Consequently, the first brake 14, in its activated position, holds the transmission output 9/ring gear 8 of the planetary gearbox 7 (relative to a transmission housing 15) (to implement the purely electric drive mode); in its deactivated position, it releases a rotation of the ring gear 8/transmission output 9 (to implement the hybrid drive mode).

The powershift transmission 5, as can then be seen particularly well in connection with FIG. 2, is implemented as a Ravigneaux gear set 16. The powershift transmission 5 is therefore implemented as a manual gearbox, in this case as a planetary gearbox. In further embodiments, the powershift transmission 5 is also implemented as a CVT transmission.

In accordance with the structure of a Ravigneaux gear set 16, the powershift transmission 5 has a common ring gear 17. The ring gear 17 directly forms the transmission output 9 and is permanently connected in a non-rotatable manner to the ring gear 8 of the planetary gearbox 7. A common planet carrier 22 of the powershift transmission 5 rotatably accommodates several planetary gears not shown further here for the sake of clarity. A first set of planet gears is in meshing engagement with a first sun gear 20 and ring gear 17. A second set of planet gears is in meshing engagement with a second sun gear 24 and ring gear 17. The planet gears of both sets are differently dimensioned and rotatably mounted between the respective sun gear 20, 24 and the ring gear 17 on the joint planetary gearbox 22 for implementing different gear ratios i2, i3 (ii indicates a gear ratio of the planetary gearbox 7 in FIG. 2).

As can also be seen in FIG. 2, the output shaft 18 can be coupled to the individual components of the powershift transmission 5 via several different clutches 19, 21 and 23. A first clutch 19 is arranged between the output shaft 18/the input 28 of the powershift transmission 5 and the first sun gear 20. This first clutch 19 is implemented as a claw clutch. A second clutch 21 is arranged between the output shaft 18/the input 28 and the planet carrier 22. The second clutch 21 is implemented as a friction clutch. A third clutch 23 is operatively interposed between the output shaft 18/input 28 and the second sun gear 24. The third clutch 23 is also implemented as a friction clutch.

Furthermore, a brake 25, 26 acts on both the first sun gear 20 and the planet carrier 22. A second brake 25, implemented as a friction clutch, acts on the first sun gear 20. A third brake 26, also implemented as a friction brake, acts on the planet carrier 22.

In other words, a simple transmission chain having a planetary gear set (planetary gearbox 7) is selected for the electric motor branch (first part-unit 3) of the powertrain 1. Preferably, the electric motor (electrical machine 2) is connected to the sun gear 12 and the output drive 10 is connected to the planet carrier 13. The internal combustion engine branch (second part-unit 6) consists of the internal combustion engine 4 and a powershift transmission (powershift transmission 5), the output 9 of which is connected to the ring gear 8 of the planetary gear set 7. This connection of the planetary gear set 7, hereinafter also referred to as coupling planetary gear set, allows a higher electric motor speed and thus a smaller installation space of the electric motor 2 to be used. The coupling of the two powertrain branches 3, 6 via the coupling planetary gear set 7 results in a speed additive connection of the two branches 3, 6. The torques of the electric motor branch 3, the internal combustion engine branch 6 and the output drive 10 form an equilibrium of torques, and the speeds can be set differently.

In an electric mode (or purely electric drive mode), the ring gear 8 of the coupling planetary gear set 7 is connected to the transmission housing 15 via a claw brake 14 in a non-rotatable manner. The internal combustion engine branch 6 is stationary here so that no unnecessary losses occur. In this mode, the vehicle behaves like a pure electric vehicle. In hybrid mode (hybrid drive mode), the claw brake 14 on the ring gear 8 of the coupling planetary gear set 7 is released, the internal combustion engine 4 and thus also the output 9 of the powershift transmission 5 (=ring gear 8 of the coupling planetary gear set 7), rotate.

In this regard, there are a number of different operating modes:

Stationary charging: Here, the output drive 10 (planet carrier 13 of the coupling planetary gear set 7) is held in place by a vehicle brake or a parking lock (torque support).

Tractive forward motion (with positive output torque): Here, the claw brake 14 is released. The sum of the torques of the internal combustion engine 4 and electric motor 2 forms the output torque. Ideally, the electric motor 2 is used here as a generator (negative speed at positive torque) to charge the vehicle battery. However, a boost operation is also conceivable.

Tractive reverse motion (with negative output torque): This is possible in analogy to the previous point, if the powershift transmission 5 has a reverse gear. Otherwise, only purely electric reversing is possible.

Thrust forward motion (with negative output torque): Also referred to simply as recuperation (recovery of vehicle kinetic energy) in the following. This mode is advantageous for two reasons. Firstly, part of the kinetic energy is “lost” with the drag torque of the combustion engine 4. Secondly, the drag torque of the internal combustion engine 4 is significantly smaller in magnitude than its drive torque. This limits, due to the equilibrium of moments at the coupling planetary gear set 7, the braking torque at the output drive 10 and also the recoverable power in the electric motor 2. Therefore, a switch to a pure electric mode is always desirable here.

Starting the internal combustion engine 4 from the powertrain: This is feasible with a probably noticeable modulation of the output torque. Preferably, therefore, a starter motor is provided on the internal combustion engine 4.

Pure internal combustion engine driving (without using the electric motor 2) is not initially envisaged in this transmission concept. To make this possible, another claw brake would be required at the connection from the sun gear 12 of the coupling planetary gear set 7 to the electric motor 2.

In the internal combustion engine branch 6, there is either a manual transmission 5 or, if necessary, also a CVT, in order to be able to support sufficiently high output torques on the one hand, and on the other hand to still enable regenerative operation of the electric motor 2 (negative electric motor speed with positive electric motor torque) even at high vehicle speeds. A powershift capability of the transmission 5 is preferable for convenience reasons. In the following, we will therefore make reference to a powershift transmission 5. However, the required transmission spread is smaller than for a pure internal combustion engine vehicle or for a parallel hybrid drive with torque-additive coupling of the two branches. The smallest gear does not need to spare the starting clutch. The corresponding “slip” is transferred to the electric motor 2 via the coupling planetary gear set 7 and serves here as input power for the generator. Due to the smaller overall spread, a smaller number of gear stages may also be sufficient. In all cases, however, at least one friction clutch is required in the internal combustion engine powertrain in order to be able to switch between the electric mode and hybrid mode under load.

The concrete example according to FIGS. 1 and 2 shows for a simple powershift transmission in the internal combustion engine powertrain branch 6 a Ravigneaux planetary gear set 16 having three clutches 19, 21, 23 and two brakes 25, 26. The brakes 25, 26 and two of the clutches 21, 23 are friction clutches or brakes. A clutch 19 may also be implemented as a space-saving claw clutch. This means that four forward gears and one reverse gear can be implemented.

Load shifts in the transmission 5 are implemented in the usual gearbox manner, wherein a change in the electric motor speed can also be used here in the synchronous phases of the shifts to support the speed adaptation in order to minimize the frictional energies occurring in the friction elements. The usual vibration dampers (DMF; centrifugal pendulum, . . . ) can be used in the internal combustion engine branch 6 of the powertrain 1. Switching between electric driving (electric mode) and hybrid driving (hybrid mode) is similar to starting uphill in a conventional powertrain. When the internal combustion engine 4 is running and the output drive (transmission output 9) of the powershift transmission 5 is stationary (claw brake 14 engaged), torque is built up at the transmission output 9 via a friction element (clutch or brake) in the transmission so that the holding torque is taken over by the claw brake 14 from the transmission output 9. Once the torque has been taken over, the claw brake 14 can be disengaged. This is followed by speed adaptation so that the slipping friction element can be brought into adhesion. For this purpose, it is advantageous to adapt the speed of the electric motor 2 accordingly. Ideally such that now the electric motor speed becomes negative (generator operation) so that the battery can be charged.

The change from hybrid mode to electric mode takes place in reverse order: Build-up of slip at the friction element in the transmission 5 for lowering the speed of the ring gear 8 in the coupling planetary gear set 7 (transmission output 9). If this speed is sufficiently low, the claw brake 14 can be engaged and the friction element opened. If recuperation is required in hybrid mode (recovery of kinetic energy of the vehicle), the small drag torque of the internal combustion engine 4 can be effectively increased by selective tensioning in the powershift transmission 5. This means that higher electric motor torques are then also possible in the equilibrium of moments at the coupling planetary gear set 7. However, it is better to switch to electric mode, because here no kinetic energy is used to “heat” friction elements, but more energy can actually be recovered in the electric motor 2.

### LIST OF REFERENCE SYMBOLS

1 Powertrain unit

2 Electrical machine

3 First part-unit

4 Internal combustion engine

5 Powershift transmission

6 Second part-unit

7 Planetary gearbox

8 Ring gear of the planetary gearbox

9 Transmission output

10 Output drive

11 Rotor shaft

12 Sun gear of the planetary gearbox

13 Planet carrier of the planetary gearbox

14 First brake

15 Transmission housing

16 Ravigneaux gear set

17 Ring gear of the powershift transmission

18 Output shaft

19 First clutch

20 First sun gear of the powershift transmission

21 Second clutch

22 Planet carrier of the powershift transmission

23 Third clutch

24 Second sun gear of the powershift transmission

25 Second brake

26 Third brake

27 Planetary gear of the planetary gearbox

28 Input

1. A hybridized powertrain unit for a motor vehicle, the powertrain unit comprising:
a first part-unit having an electrical machine;
a second part-unit having an internal combustion engine;
a powershift transmission connected downstream of the internal combustion engine; and
a joint planetary gearbox, the first and second part-units are coupled on an output side to an output drive via the joint planetary gearbox, and the joint planetary gearbox includes a ring gear that is connected to a transmission output of the powershift transmission.

2. The powertrain unit according to claim 1, wherein a rotor shaft of the electrical machine is connected in a non-rotatable manner to a sun gear of the joint planetary gearbox.

3. The powertrain unit according to claim 1, wherein the ring gear of the planetary gearbox is acted upon by a brake which, in an activated position, retains the ring gear relative to a transmission housing of the powershift transmission.

4. The powertrain unit according to claim 1, wherein the powershift transmission has a Ravigneaux gear set or directly forms said Ravigneaux gear set.

5. The powertrain unit according to claim 1, wherein a ring gear of the powershift transmission is connected to the ring gear of the planetary gearbox.

6. The powertrain unit according to claim 1, wherein an output shaft of the internal combustion engine is at least one of connectable via a first clutch to a first sun gear of the powershift transmission, connectable via a second clutch to a planet carrier of the powershift transmission, or connectable via a third clutch to a second sun gear of the powershift transmission.

7. A method for operating a powertrain unit according to claim 1, wherein the method comprises: in a hybrid drive mode, the internal combustion engine driving the ring gear of the planetary gearbox via the powershift transmission, in addition to a drive power transmitted from the electrical machine to the planetary gearbox, and in a purely electric drive mode, only the electrical machine transmitting drive power to the planetary gearbox, while a transmission output of the powershift transmission is held fixed to a transmission housing.

8. The method according to claim 7, wherein, during a change from the purely electric drive mode to the hybrid drive mode, the internal combustion engine uncoupled from the powershift transmission is first switched on, then, by a targeted slipping operation of a friction clutch arranged between an output shaft of the internal combustion engine and a component of the powershift transmission, a defined torque is built up in a claw brake holding the transmission output, then the claw brake is opened and, in turn, a speed adaptation is performed between the output shaft of the internal combustion engine and the transmission output, whereupon the friction clutch is completely closed.

9. The method according to claim 8, wherein the speed adaptation between the output shaft of the internal combustion engine and the transmission output is performed by adapting a speed of the electrical machine.

10. The method according to claim 7, wherein, during a change from the hybrid drive mode to the purely electric drive mode, a friction clutch between an output shaft of the internal combustion engine and a component of the power shift transmission is brought into a targeted slipping operation and a speed of the transmission output is reduced, and subsequently, after the speed of the transmission output has reached or fallen below a lower speed limit value, a claw brake acting on the transmission input is closed and the friction clutch is fully opened.

11. The powertrain unit according to claim 1, wherein a planet carrier of the planetary gearbox is connected to the output drive.

12. A hybridized powertrain unit for a motor vehicle, the powertrain unit comprising:
an electrical machine having a rotor shaft;
an internal combustion engine having an output shaft;
a powershift transmission connected to the output shaft of the internal combustion engine; and
a joint planetary gearbox that connects the rotor shaft to an output drive, and the joint planetary gearbox includes a ring gear that is connected to a transmission output of the powershift transmission to transmit an output from the output shaft o the output drive.

13. The powertrain unit according to claim 12, wherein the rotor is connected in a non-rotatable manner to a sun gear of the joint planetary gearbox.

14. The powertrain unit according to claim 12, wherein a planet carrier of the planetary gearbox is connected to the output drive.

15. The powertrain unit according to claim 12, further comprising a brake configured to act upon the ring gear of the planetary gearbox which, in an activated position, retains the ring gear relative to a transmission housing of the powershift transmission.

16. The powertrain unit according to claim 12, wherein the powershift transmission has a Ravigneaux gear set or directly forms said Ravigneaux gear set.

17. The powertrain unit according to claim 12, wherein a ring gear of the powershift transmission is connected to the ring gear of the planetary gearbox.

18. The powertrain unit according to claim 12, wherein the output shaft is at least one of connectable via a first clutch to a first sun gear of the powershift transmission, connectable via a second clutch to a planet carrier of the powershift transmission, or connectable via a third clutch to a second sun gear of the powershift transmission.
